(19) United States
(12) Patent Application Publication
(10) Pub. No.: US 2022/0139245 A1
(43) Pub. Date: May 5, 2022

(54) USING PERSONALIZED KNOWLEDGE PATTERNS TO GENERATE PERSONALIZED LEARNING-BASED GUIDANCE

(71) Applicant: International Business Machines Corporation, Armonk, NY (US)

(72) Inventors: John D. Wilson, League City, TX (US); Shikhar Kwatra, San Jose, CA (US); Jeremy R. Fox, Georgetown, TX (US); Sarbajit K. Rakshit, Kolkata (IN)

(21) Appl. No.: 17/088,949

(22) Filed: Nov. 4, 2020

(51) Int. Cl. G09B 7/02; G06F 16/2457; G06N 20/00; G09B 19/00

(52) U.S. Cl. CPC G09B 7/02; G09B 19/00; G06N 20/00; G06F 16/2457

(57) ABSTRACT

Embodiments of the invention are directed to a computer-implemented method of generating personalized learning-based guidance. The computer-implemented method includes receiving at a question and answer (Q&A) module a user inquiry from a user. A knowledge pattern model of Q&A module is used to identify a knowledge pattern of the user, wherein the knowledge pattern of the user includes a learning-assist process that assists a discovery process implemented by the user and through which the user discovers an answer to the user inquiry. The knowledge pattern is used to generate the personalized learning-based guidance, wherein the personalized learning-based guidance includes a communication configured to assist the user with performing a task of acquiring a target knowledge that can be used by the user to generate the answer to the user inquiry.

### BACKGROUND

The present invention relates in general to programmable computers. More specifically, the present invention relates to computing systems, computer-implemented methods, and computer program products that cognitively facilitate a user's learning by identifying personalized knowledge patterns of the user, and using the personalized knowledge patterns of the user to generate and provide personalized learning-based guidance to the user.

A dialogue system or virtual assistant (VA) is a computer system configured to communicate with a human using a coherent structure. Dialogue systems can employ a variety of communication mechanisms, including, for example, text, speech, graphics, haptics, gestures, and the like for communication on input and output channels. Dialogue systems can employ various forms of natural language processing (NLP), which is a field of computer science, artificial intelligence, and computational linguistics concerned with the interactions between computers and humans using language. Among the challenges in implementing NLP systems is enabling computers to derive meaning from NL inputs, as well as the effective and efficient generation of NL outputs.

### SUMMARY

Embodiments of the invention are directed to a computer-implemented method of generating personalized learning-based guidance. The computer-implemented method includes receiving at a question and answer (Q&A) module a user inquiry from a user. A knowledge pattern model of Q&A module is used to identify a knowledge pattern of the user, wherein the knowledge pattern of the user includes a learning-assist process that assists a discovery process implemented by the user and through which the user discovers an answer to the user inquiry. The knowledge pattern is used to generate the personalized learning-based guidance, wherein the personalized learning-based guidance includes a communication configured to assist the user with performing a task of acquiring a target knowledge that can be used by the user to generate the answer to the user inquiry.

Embodiments of the invention are also directed to computer systems and computer program products having substantially the same features as the computer-implemented method described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1A depicts a block diagram illustrating a system according to embodiments of the invention;

FIG. 1B depicts a block diagram illustrating a system according to embodiments of the invention;

FIG. 2 depicts a table illustrating examples of learning-based guidance that can be generated according to embodiments of the invention;

FIG. 3A depicts a block diagram illustrating a system hardware configuration according to embodiments of the invention;

FIG. 3B depicts a flow diagram illustrating a methodology according to embodiments of the invention;

FIG. 4A depicts a block diagram illustrating how portions of a system can be implemented in according to embodiments of the invention;

FIG. 4B depicts a block diagram illustrating how portions of a system can be implemented in according to embodiments of the invention;

FIG. 4C depicts a block diagram illustrating how portions of a system can be implemented in according to embodiments of the invention;

FIG. 4D depicts a block diagram illustrating how portions of a system can be implemented in according to embodiments of the invention;

FIG. 5 depicts a block diagram illustrating how portions of a system can be implemented in according to embodiments of the invention;

FIG. 6A depicts a graphical text analyzer's output feature vector that includes an ordered set of words or phrases, wherein each is represented by its own vector according to embodiments of the invention;

FIG. 6B depicts a graph of communications according to embodiments of the invention;

FIG. 7 depicts a vector and various equations illustrating a core algorithm of a graphical text analyzer in accordance with embodiments of the invention;

FIG. 8 depicts of a diagram of a graphical text analysis system according to embodiments of the invention;

FIG. 9 depicts a machine learning system that can be utilized to implement aspects of the invention;

FIG. 10 depicts a learning phase that can be implemented by the machine learning system shown in FIG. 9; and

FIG. 11 depicts details of an exemplary computing system capable of implementing various aspects of the invention.

FIG. 12 depicts a cloud computing environment according to embodiments of the invention; and

FIG. 13 depicts abstraction model layers according to an embodiment of the invention.

In the accompanying figures and following detailed description of the disclosed embodiments, the various elements illustrated in the figures are provided with three digit reference numbers. In some instances, the leftmost digits of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

As used herein, in the context of machine learning algorithms, the terms “input data” and variations thereof are intended to cover any type of data or other information that is received at and used by the machine learning algorithm to perform training, learning, and/or classification operations.

As used herein, in the context of machine learning algorithms, the terms “training data” and variations thereof are intended to cover any type of data or other information that is received at and used by the machine learning algorithm to perform training and/or learning operations.

As used herein, in the context of machine learning algorithms, the terms “application data,” “real world data,” “actual data,” and variations thereof are intended to cover any type of data or other information that is received at and used by the machine learning algorithm to perform classification operations.

As used herein, the term “state” and variations thereof are intended to convey a temporary way of being (i.e., thinking, feeling, behaving, and relating). As used herein, the term “trait” and variations thereof are intended to convey a more stable and enduring characteristic or pattern of behavior. States can impact traits. For example, someone with a character trait of calmness and composure can, under certain circumstances, act agitated and angry because of being in a temporary state that is uncharacteristic of his or her more stable and enduring characteristics or patterns of behavior.

As used herein, the terms “emotional state” and variations thereof are intended to identify a mental state or feeling that arises spontaneously rather than through conscious effort and is often temporary and accompanied by physiological changes. Examples of emotional states include feelings of joy, sorrow, anger, and the like.

As used herein, the terms “cognitive trait,” “personality trait,” and variations thereof are intended to convey a more stable and enduring cognitive/personality characteristic or pattern of behavior, which can include generally accepted personality traits in psychology. Non-limiting examples of generally accepted cognitive/personality traits in psychology include but are not limited to the big five personality traits (also known as the five-factor model (FFM)) and their facets or sub-dimensions, as well as the personality traits defined by other models such as Kotler's and Ford's Needs Model and Schwartz's Values Model. The FFM identifies five factors, which are openness to experience (inventive/curious vs. consistent/cautious); conscientiousness (efficient/organized vs. extravagant/careless); extraversion (outgoing/energetic vs. solitary/reserved); agreeableness (friendly/compassionate vs. challenging/callous); and neuroticism (sensitive/nervous vs. resilient/confident). The terms personality trait and/or cognitive trait identifies a representation of measures of a user's total behavior over some period of time (including musculoskeletal gestures, speech gestures, eye movements, internal physiological changes, measured by imaging devices, microphones, physiological and kinematic sensors in a high dimensional measurement space) within a lower dimensional feature space. One more embodiments of the invention use certain feature extraction techniques for identifying certain personality/cognitive traits.

As used herein, the terms “personalized knowledge pattern” and variations thereof are intended to identify an individual's preferential and/or most effective knowledge acquisition process or method that enables or assists that person to acquire or learn new information or a new skill.

As used herein, the terms “personalized discovery pattern” and variations thereof are intended to identify an individual's preferential and/or most effective discovery (or “self-help”) process or method that enables or assists that person to discover or learn information or a skill for herself/himself.

As used herein, the term “student” is used in the broadest sense to include not only persons participating in formal educational systems/environments such as elementary schools, high schools, colleges, and universities, but also persons participating in informal learning systems/environments such as corporate training, sports teams, professional training, seminars, and the like.

As used herein, the terms “learning styles” and variations thereof are intended to identify the preferential way in which a person absorbs, processes, comprehends and retains information. Examples of learning styles include the so-called VARK model of student learning, wherein VARK is an acronym that refers to four types of learning styles, namely, visual, auditory, reading/writing preference, and kinesthetic. As an example, when learning how to build a clock, some students understand the process best by watching a demonstration (or viewing diagrams); some students understand the process best by following verbal instructions; some students understand the process best by reading written versions of the instructions; and some students understand the instructions best through physically manipulating the clock themselves.

As used herein, the terms “human interaction,” “interaction,” and variations thereof are intended to identify the various forms of communication that can be passed between and among humans, as well as between and among humans and another entity, in a variety of environments or channels. The entity can be any entity (e.g., human and/or machine) capable of engaging a human in a communication. The forms of communication include natural language, written text, physical gestures, facial expressions, physical contact, and the like. The variety of environments/channels include face-to-face or in-person environments, as well as remote or virtual environments where one environment is connected to another through electronic means. An example of an interaction is the exchange of communication between learners and teacher and among learners during an in-person or remote/virtual learning process. Another example of an interaction is the exchange of communication between learners and a Q&A system and among learners during an in-person or remote/virtual learning process.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

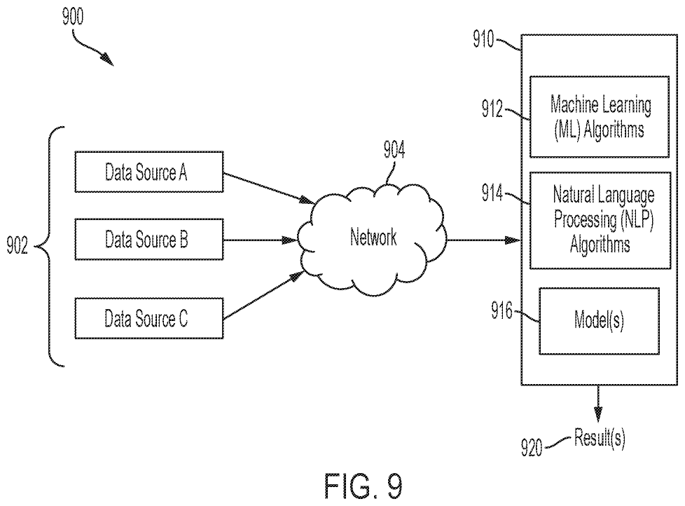

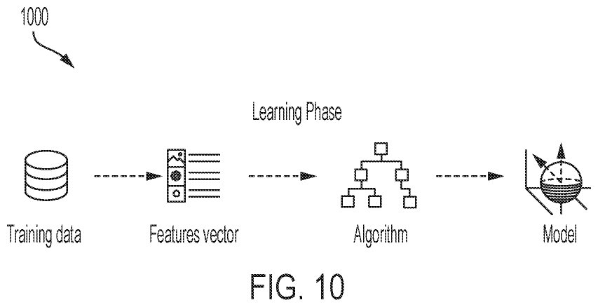

Many of the functional units of the systems described in this specification have been labeled as models. Embodiments of the invention apply to a wide variety of model implementations. For example, the models described herein can be implemented as machine learning algorithms and natural language processing algorithms configured and arranged to uncover unknown relationships between data/information and generate a model that applies the uncovered relationship to new data/information in order to perform an assigned task of the model. In aspects of the invention, the models described herein can have all of the features and functionality of the models depicted in FIGS. 9 and 10 and described in greater detail subsequently herein. As another example, in some embodiments of the invention described herein, instead of implementing the models described herein as machine learning models they can be implemented as equivalent computer-implemented analysis algorithms such as simulation algorithms, computer-controlled relational databases, and the like.

The various components/modules/models of the systems illustrated herein are depicted separately for ease of illustration and explanation. In embodiments of the invention, the functions performed by the various components/modules/models can be distributed differently than shown without departing from the scope of the embodiments of the invention described herein unless it is specifically stated otherwise.

Turning now to an overview of aspects of the invention, embodiments of the invention provide computing systems, computer-implemented methods, and computer program products that cognitively facilitate a user's learning by identifying personalized knowledge patterns of the user; using the personalized knowledge patterns to identify relationships between the user's existing knowledge and the user's target knowledge; and using the identified relationships to generate and provide personalized learning-based guidance to the user.

In embodiments of the invention, a user submits an inquiry to a Q&A system. In accordance with aspects of the invention, the Q&A system is configured to incorporate a personalized knowledge pattern model of the user. The personalized knowledge pattern model of the user has been trained to perform the task of identifying the personalized knowledge patterns of the user, wherein the identified knowledge patterns includes a learning-assist process that assists a discovery process that can be implemented by the user and through which the user discovers an answer to the user inquiry. The knowledge pattern is used to generate the personalized learning-based guidance, wherein the personalized learning-based guidance includes a communication configured to assist the user with performing a task of acquiring a target knowledge that can be used by the user to generate the answer to the user inquiry.

Accordingly, the personalized knowledge pattern model of the user is configured and arranged to perform the task of identifying the contextualized and personalized “knowledge patterns” of the user, wherein the knowledge patterns of the user include the knowledge discovery processes/methods that are most effective for enabling and/or assisting the user to leverage the user's historical/existing knowledge to discover or learn for herself/himself the target knowledge that is necessary to answer the user inquiry 114

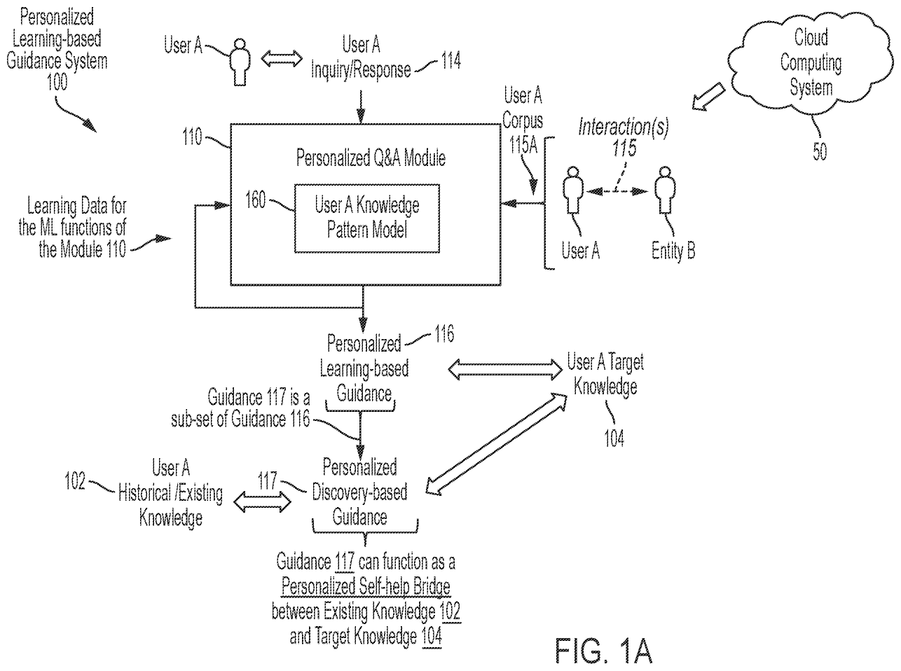

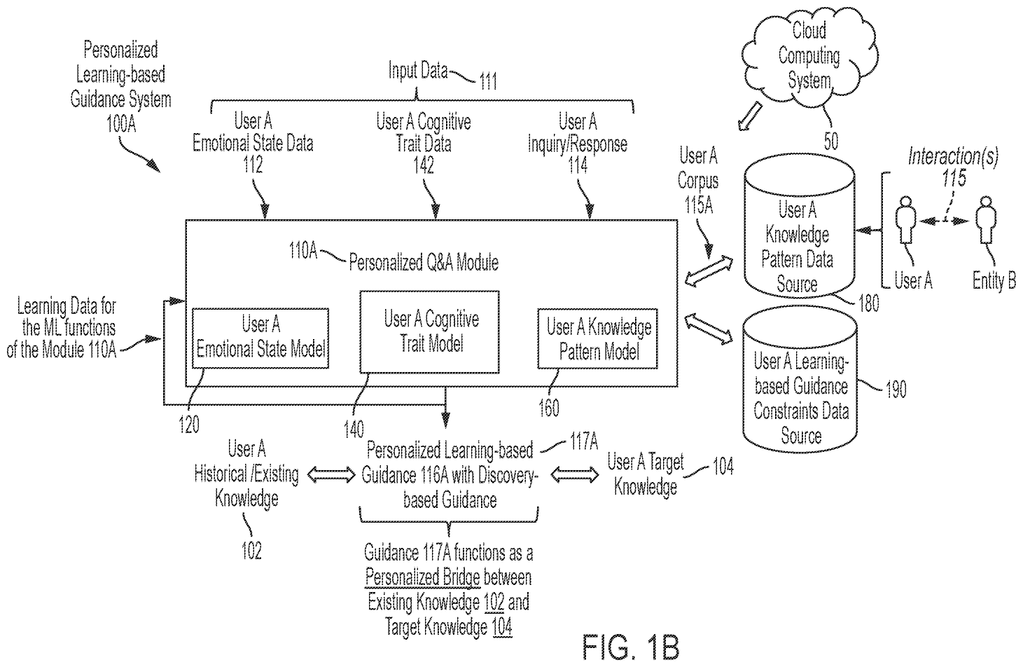

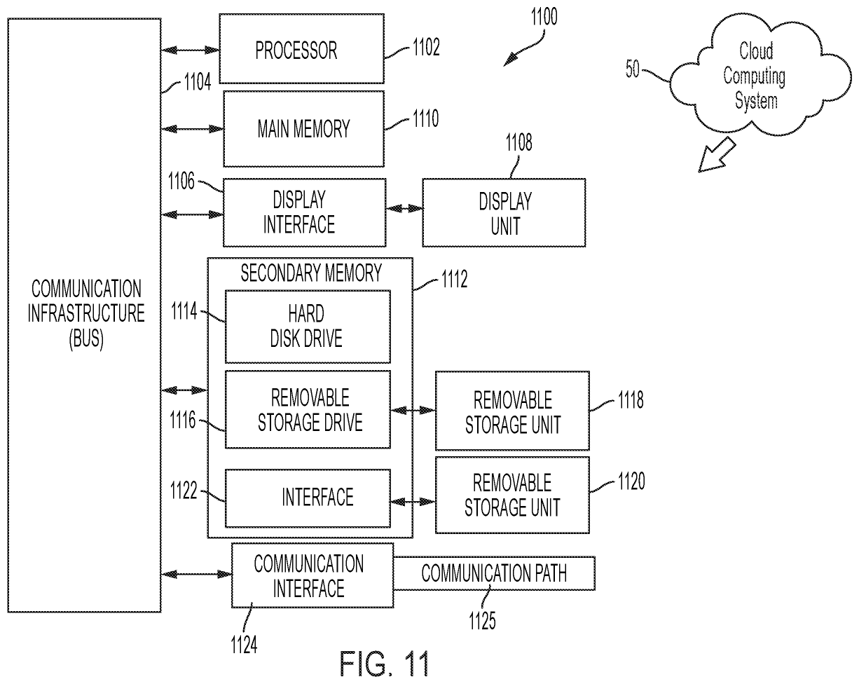

Turning now to a more detailed description of the aspects of the present invention, FIG. 1A depicts a diagram illustrating a personalized learning-based guidance system 100 according to embodiments of the invention. In the broadest sense, the system 100 can be implemented as algorithms executed by a programmable computer such as a computing system 1100 (shown in FIG. 11). The system 100 includes a computer-based personalized Q&A module 110 configured to incorporate a trained User A knowledge pattern model 160 such that the answers generated by the personalized Q&A module are influenced by the task(s) performed by the User A knowledge pattern model 160. The computer-based personalized Q&A module 110 is a modified version of known types of Q&A systems that provide answers to natural language questions. As a non-limiting example, the system 100 can include all of the features and functionality of a DeepQA technology developed by IBM®. DeepQA is a Q&A system that answers natural language questions by querying data repositories and applying elements of natural language processing, machine learning, information retrieval, hypothesis generation, hypothesis scoring, final ranking, and answer merging to arrive at a conclusion. Such Q&A systems are able to assist humans with certain types of semantic query and search operations, such as the type of natural question-and-answer paradigm of an educational environment. Q&A systems such as IBM's DeepQA technology often use unstructured information management architecture (UIMA), which is a component software architecture for the development, discovery, composition, and deployment of multi-modal analytics for the analysis of unstructured information and its integration with search technologies developed by IBM®.

In accordance with aspects of the invention, the personalized Q&A module 110 and the User A knowledge pattern model 160 are configured and arranged to, in response to various types of input data (e.g., an inquiry 114 from User A), cognitively facilitate User A's learning by generating learning-based guidance 116 that has been personalized for User A. In embodiments of the invention, the personalized learning-based guidance 116 is a communication designed by the personalized Q&A module 110 and the User A knowledge pattern model 160 to match or align with User A's preferential and/or most effective knowledge acquisition process or method that enables User A to acquire (or assists User A with acquiring or learning) the User A target knowledge 104. In accordance with aspects of the invention, the User A target knowledge 104 includes knowledge that is necessary in order to answer the User A inquiry 114. In accordance with aspects of the invention, the User A knowledge pattern model 160 can be a machine learning model that has been trained by extracting features from a User A corpus 115A in order to learn to perform the task of determining User A's preferential and/or most effective knowledge acquisition process or method that enables User A to acquire/learn (or assists User A with acquiring/learning) the User A target knowledge 104. The personalized Q&A module 110 leverages the knowledge acquisition process generated by the knowledge pattern model 160 to generate the personalized learning-based guidance 116, which is the previously-described communication that has been configured to enable User A to acquire (or assist User A with acquiring or learning) the User A target knowledge 104. As an example, the User A inquiry 114 can be “What is the formula of tan(θ)”; the preferred User A knowledge acquisition process can be “provide a direct answer with an illustration”; and the personalized learning-based guidance 116 can be the actual formula used to calculate the tangent of the angle θ of a right triangle, along with one or more images that illustrate the concepts conveyed by the formula. In aspects of the invention, the personalized learning-based guidance 116 can take a variety of forms including but not limited to audible and/or written natural language, images, video, animation video, sign language, and the like.

In embodiments of the invention, the User A corpus 115A includes information that reflects interactions 115 that have occurred in the past between User A and another person/entity represented in FIG. 1A as Entity B. In some embodiments of the invention, User A is a student, Entity B is a teacher (human or machine-based), and the interaction(s) 115 are the various forms of communication that can be passed between and students and teachers during a learning process. The various forms of communication include written and/or spoken natural language, physical gestures, facial expressions, physical contact, and the like.

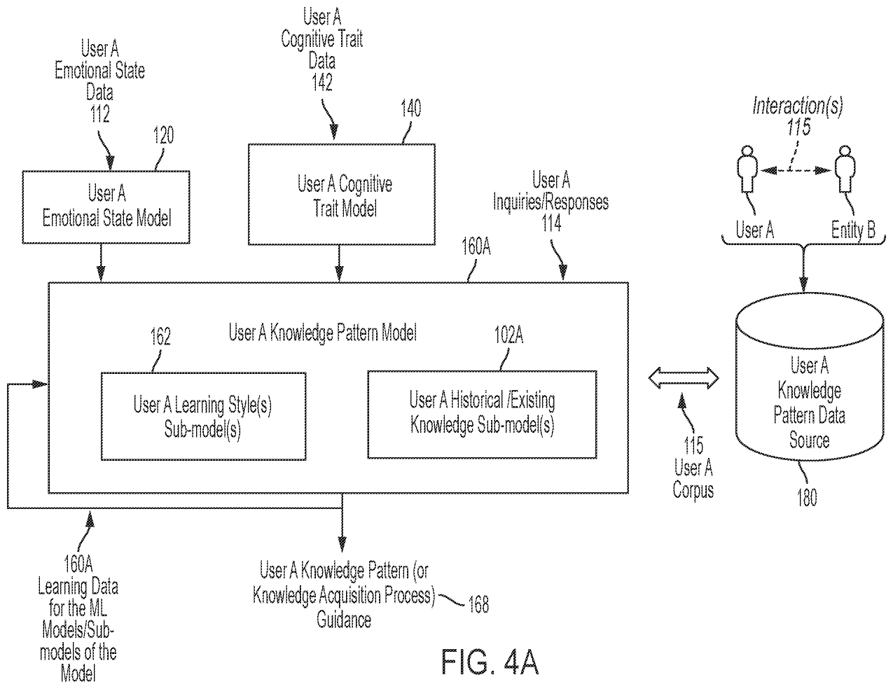

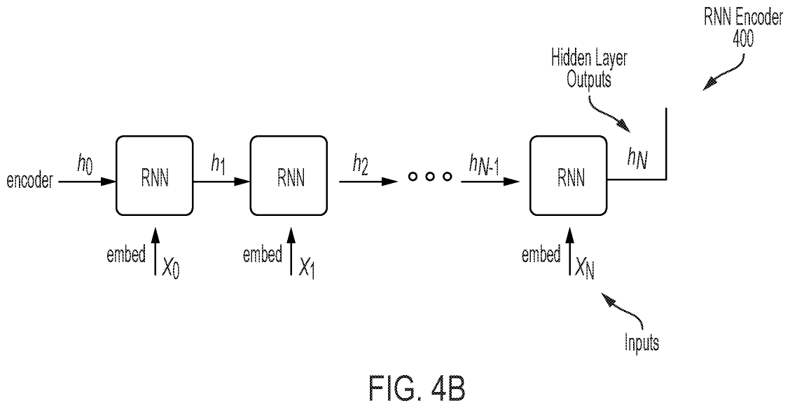

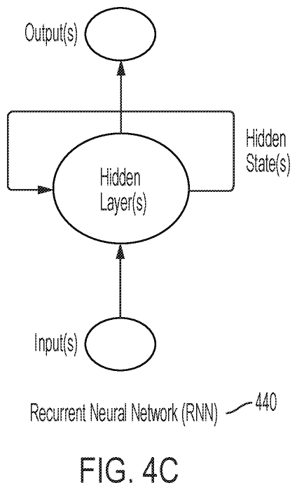

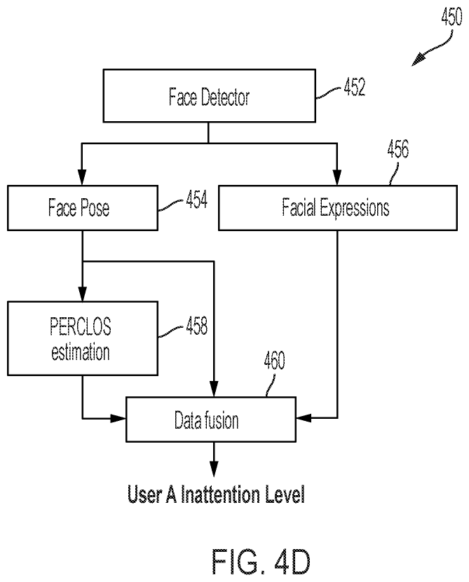

In embodiments of the invention, the previously-described training applied to the User A knowledge pattern model 160 can further include extracting features from the interactions 115 of the User A corpus 115A in order to perform the task of determining User A's preferential and/or most effective discovery (or “self-help”) process or method that enables User A to discover/learn (or assists User A with discovering/learning) the User A target knowledge 104 for herself/himself. The personalized Q&A module 110 leverages the User A knowledge discovery process generated by the knowledge pattern model 160 to generate the personalized learning-based guidance 116 such that the guidance 116 includes personalized discovery-based guidance 117. As an example, the User A inquiry 114 can be “What is the formula of tan(θ)”; the preferred User A knowledge discovery process can be “provide hints and/or analogies”; and the personalized discovery-based guidance 117 can be “you can do it, think about a triangle and . . . ” and/or “remember the acronym you learned to help you remember this formula.” In aspects of the invention, similar to the personalized learning-based guidance 116, the personalized discovery-based guidance 117 can take a variety of forms including but not limited to audible and/or written natural language, images, video, animation video, sign language, and the like. Accordingly, as depicted in FIG. 1A, the personalized discovery-based guidance 117 is a communication that enables or assists User A with performing the task of leveraging User A historical/existing knowledge 102 in order to “discover” the User A target knowledge 104, which is knowledge that is necessary in order to answer the User A inquiry 114. In other words, the personalized discovery-based guidance 117 functions as a personalized “self-help” bridge between User A's existing knowledge 102 and User A's target knowledge 104. In embodiments of the invention, the User A historical knowledge 102 includes a wide variety of information types that reflect information and/or skills that User A has learned or been exposed to in the past. In embodiments of the invention, the User A historical/existing knowledge can be extracted from the User A corpus 115A, and specifically from the interactions 115 by the User A knowledge pattern model 160. Additional details of how a User A historical/existing knowledge model 102A can be used to generate the User A historical/existing knowledge 102 are depicted in FIG. 4A and described in greater detail subsequently herein. Additional details of how the User A corpus 115A can be built are depicted in FIG. 4B and described in greater detail subsequently herein.

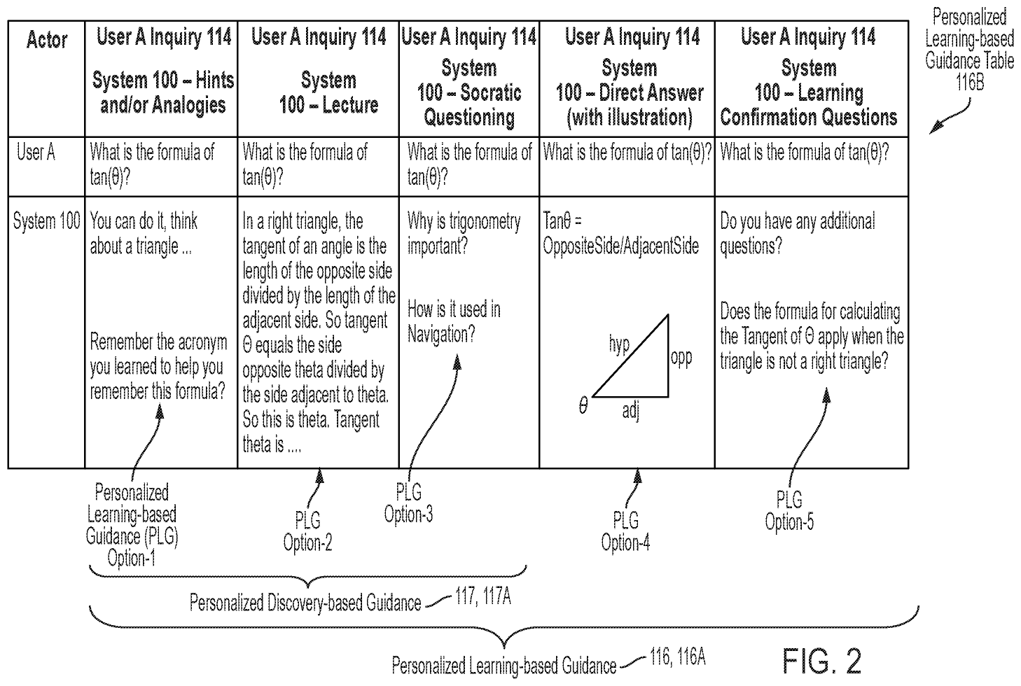

Accordingly, the User A knowledge pattern model 160 in accordance with aspects of the invention is configured and arranged to perform the task of identifying the contextualized and personalized “knowledge patterns” of User A, wherein the knowledge patterns of User A include the knowledge discovery processes/methods that are most effective for enabling and/or assisting User A to leverage the User A historical/existing knowledge 102 to discover or learn for herself/himself the User A target knowledge 104 that is necessary to answer the User A inquiry 114. In embodiments of the invention, the personalized Q&A module 110 is configured to perform a modified version of the previously-described Q&A system functionality by using the User A knowledge pattern model 160 to identify or determine the personalized knowledge patterns of User A; use the personalized knowledge patterns to identify relationships between the User A historical/existing knowledge 102 and the User A target knowledge 104 that match the personalized knowledge patterns of User A; use the identified relationships to generate learning-based guidance 116, 117 that is personalized for User A; and provide the personalized learning-based guidance 116, 117 to User A in a suitable format, including spoken and/or written natural language, images, physical gestures, video, and the like. In embodiments of the invention, the personalized learning-based guidance 116, 117 can be fed back into the module 110 to provide additional learning or training data for the various machine learning (ML) functions of the module 110. Examples of the personalized learning-based guidance 116, which includes the personalized discover-based guidance 117, are depicted in FIG. 2 and described in greater detail subsequently herein.

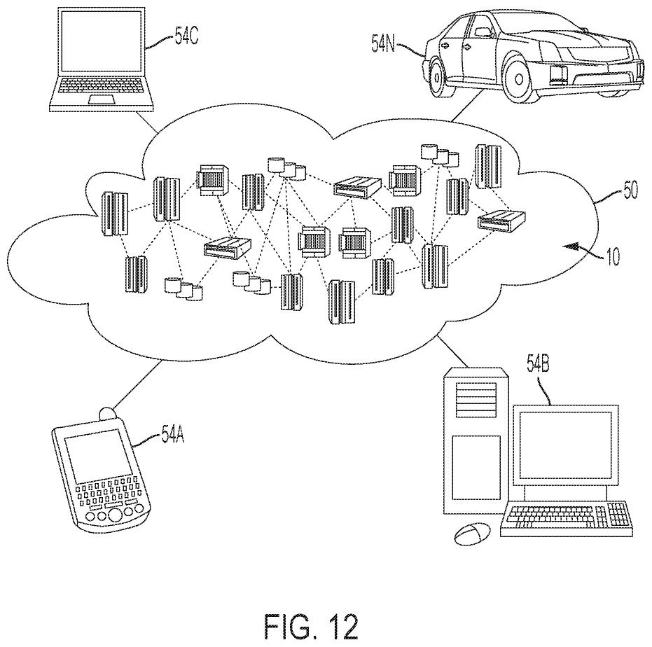

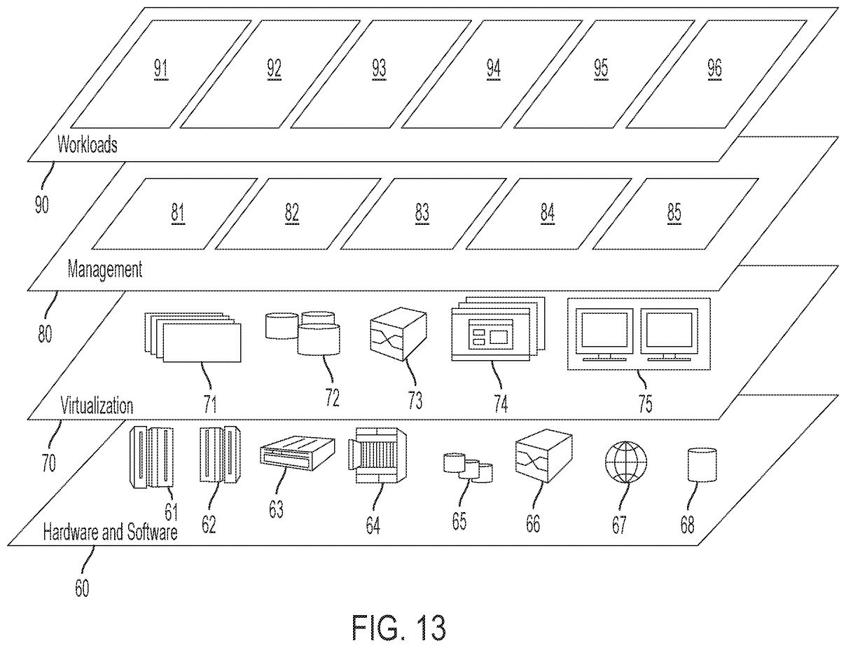

A cloud computing system 50 (also shown in FIGS. 1B, 11 and 12) is in wired or wireless electronic communication with the system 100. The cloud computing system 50 can supplement, support or replace some or all of the functionality of the personalized learning-based guidance system 100. Additionally, some or all of the functionality of the system 110 can be implemented as a node 10 (shown in FIGS. 12 and 13) of the cloud computing system 50.

FIG. 1B depicts a diagram illustrating a personalized learning-based guidance system 100A according to embodiments of the invention. The system 100A is a more detailed example implementation of the system 100 (shown in FIG. 1A). In accordance with aspects of the invention, the system 100A includes a computer-based personalized Q&A module 110A, a User A knowledge pattern data source 180, and a User A Learning-based Guidance Constraints Data Source 190, configured and arranged as shown. In accordance with aspects of the invention, the module 110A includes the features and functionality of module 100, and further includes the additional features and functionality depicted in FIG. 1B and described subsequently herein. Accordingly, in the interest of brevity, the following descriptions of the system 100A shown in FIG. 1B will primarily focus on the additional features and functionality of the system 100A depicted in FIG. 1B.

In accordance with aspects of the invention, the personalized Q&A module 110A includes a User A emotional state model 120, a User A cognitive trait model 140, and the previously-described User A knowledge pattern model 160, which are configured and arranged to, in response to various types of input data 111, cognitively facilitate User A's learning by generating learning-based guidance 116A and discovery-based guidance 117A that have been personalized for User A. In embodiments of the invention, the personalized learning-based guidance 116A and the discovery-based guidance 117A include the features and functionality of the previously-described personalized learning-based guidance 116 and the previously-described discovery-based guidance 117. However, the personalized Q&A module 110A is configured to generate the personalized learning-based guidance 116A and the discovery-based guidance 117A by taking into account results of the supporting sub-tasks performed by the User A emotional state model 120 and the User A cognitive trait model 140.

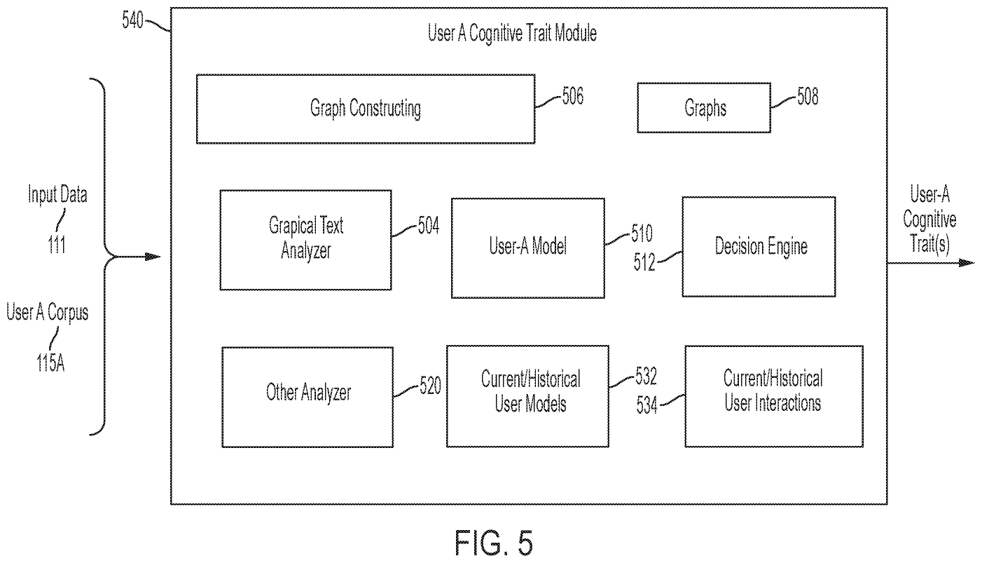

In accordance with embodiments of the invention, the User A emotional state model 120 is trained to utilize the input data 111 to perform the supporting sub-task of classifying a current emotional state of User A, which is utilized by the module 110A to generate the personalized learning-based guidance 116A and the discovery-based guidance 117A. Additional details of how the model 120 can be implemented are depicted in FIG. 4D and described in greater detail subsequently in the detailed description. In accordance with embodiments of the invention, the User A cognitive trait model 140 is trained to utilize the input data 111 to perform the supporting sub-task of classifying the current cognitive traits of User A, which are utilized by the module 110A to generate the personalized learning-based guidance 116A and the discovery-based guidance 117A. Additional details of how the model 140 can be implemented are depicted in FIGS. 5-8 and described in greater detail subsequently in the detailed description. As previously-described herein, the User A knowledge pattern model 160 is configured and arranged to perform the supporting sub-task of identifying the contextualized and personalized “knowledge patterns” of User A, wherein the knowledge patterns of User A include the discovery processes or methods that are most effective for enabling User A to leverage and/or assisting User A with leveraging the User A historical/existing knowledge 102 to discover or learn for herself/himself the User A target knowledge 104 that is necessary to answer the User A inquiry 114. Additional details of how the model 160 can be implemented are depicted in FIG. 4A and described in greater detail subsequently in this detailed description.

In accordance with aspects of the invention, the User A historical/existing knowledge 102 and/or the User A corpus 115A can be derived from the User A knowledge pattern data stored in the data source 180. In embodiments of the invention, the User A knowledge pattern data source 180 is a data source that holds a corpus of information (e.g., User A corpus 115A) about what User A knows (or should know) about a variety of topics, as well as information about the ways in which User A most effectively learns information and/or skills. In some embodiments of the invention, the data source 180 can be a relational database configured to store both data/information, as well as the relationships between and among the stored data/information. A suitable relational database that can be used in connection with embodiments of the invention is any relational database configured to provide a means of storing related information in such a way that information and the relationships between information can be retrieved from it. Data in a relational database can be related according to common keys or concepts, and the ability to retrieve related data from a table is the basis for the term relational database. A suitable relational database for implementing the data source 180 can be configured to include a relational database management system (RDBMS) that performs the tasks of determining the way data and other information are stored, maintained and retrieved from the relational database. Additional details of how the User A corpus 115A can be built from the User A knowledge pattern data source 180 are depicted in FIG. 4B and described in greater detail subsequently herein.

In embodiments of the invention, the User A learning-based guidance constraints data source 190 is a data source that holds a corpus of information about constraints, if any, that are placed on the delivery to User A of the personalized learning-based guidance 116A and the discovery-based guidance 117A generated by the personalized Q&A module 110A. For example, in embodiments of the invention where User A is a student, and where the system 100A is configured to support questions related to User A's studies, the constraints stored at the data source 190 can be set by parents, guardians, and/or teachers to explicitly state the level of help that the system 100A can provide to User A on a specified topic. Under some circumstances, a teacher can determine that User A's progress with the specified subject would be hindered by reliance on the system 100A, so a constraint could be provided that requires that no personalized learning-based guidance 116A will be provided if the User A inquiry/response 114 relates to the specified subject matter. In some embodiments of the invention, the data source 190 can be a relational database having the same features and functionality as the relational database used to implement the database 180.

Accordingly, the personalized Q&A module 110A is configured to perform a modified version of the previously-described Q&A system 100 (shown in FIG. 1A) by using the User A emotional state module 120, the User A cognitive trait model 140, and/or the User A knowledge pattern model 160 (in any combination) to identify the personalized knowledge patterns of User A; use the personalized knowledge patterns to identify relationships between the User A historical/existing knowledge 102 and the User A target knowledge 104 that match the personalized knowledge patterns of User A; use the identified relationships to generate learning-based guidance 116A that is personalized for User A; and provide the personalized learning-based guidance 116A to User A in a suitable format, including natural language audio, natural language text, images, video, and the like. In embodiments of the invention, the personalized learning-based guidance 116A can be fed back into the module 110A to provide additional learning or training data for the various machine learning (ML) functions of the module 110A. Examples of the personalized learning-based guidance 116, 116A and the personalized discovery-based guidance 117, 117A are depicted in FIG. 2 and described in greater detail subsequently herein.

A cloud computing system 50 (also shown in FIGS. 1A, 11 and 12) is in wired or wireless electronic communication with the system 100A. The cloud computing system 50 can supplement, support or replace some or all of the functionality of the personalized learning-based guidance system 100A. Additionally, some or all of the functionality of the personalized learning-based guidance system 100A can be implemented as a node 10 (shown in FIGS. 11 and 12) of the cloud computing system 50.

FIG. 2 depicts a personalized learning-based guidance table 116B that illustrates non-limiting examples of the different types of the personalized learning-based guidance 116, 116A and the personalized discovery-based guidance 117, 117A (shown in FIGS. 1A and 1B) that can be generated by the personalized Q&A modules 110, 110A (shown in FIGS. 1A and 1B). The table 116B can be stored in a memory of a computing system (e.g., memory 1110, 1112 of computer system 1100 shown in FIG. 11) configured to implement the personalized learning-based guidance systems 100, 100A (shown in FIGS. 1A and 1B). The examples of the personalized learning-based guidance 116, 116A and the personalized discovery-based guidance 117, 117A are labeled as PLG (personalized learning-based guidance) Option-1, PLG Option-2, PLG Option-3, PLG Option-4, and PLG Option-5. The module 110, 110A can be configured to generate PLG Option-1, PLG Option-2, PLG Option-3, PLG Option-4, and PLG Option-5 then populate the table 116B. The modules 110, 110A can be further configured to select PLG Option-1, PLG Option-2, PLG Option-3, PLG Option-4, and/or PLG Option-5 based on the various constraints extracted from the User A learning-based guidance constraints data source 190 (shown in FIG. 1B). In accordance with aspects of the invention, PLG Option-1, PLG Option-2, PLG Option-3, PLG Option-4, and/or PLG Option have been personalized for User A. In embodiments of the invention, PLG Option-1, PLG Option-2, PLG Option-3, PLG Option-4, and PLG Option-5 are communications designed by the personalized Q&A module 110 and the User A knowledge pattern model 160 to match or align with User A's preferential and/or most effective knowledge acquisition process or method that enables User A to acquire (or assists User A with acquiring or learning) the User A target knowledge 104. In accordance with aspects of the invention, the User A target knowledge 104 includes knowledge that is necessary in order to answer the User A inquiry 114. A subset of the personalized learning-based guidance 116, 116A is the personalized discovery-based guidance 117, 117A, which are shown in FIG. 2 as PLG Option-1, PLG Option-2, and PLG Option-3. In accordance with aspects of the invention, the personalized discovery-based guidance 117, 117A are communications that enable or assist User A with performing the task of leveraging the User A historical/existing knowledge 102 in order to “discover” the User A target knowledge 104 for herself/himself. In other words, the personalized discovery-based guidance 117, 117A functions as a personalized “self-help assistance” bridge between User A's existing knowledge 102 and User A's target knowledge 104. communications designed to enable or assist User A with performing the task of bridging the gap between User A historical/existing knowledge 102 (shown in FIGS. 1A and 1B) and the User A target knowledge 104 (shown in FIGS. 1A and 1B), which is knowledge that is necessary in order to answer the User A inquiry 114 (shown in FIGS. 1A and 1B). Included among the examples of the personalized learning-based guidance 116, 116A are PLG Option-1, PLG Option-2, and/or PLG Option-3, which are examples of the personalized discovery-based guidance 117, 117A that enables User A to acquire and/or assists User A with acquiring the User A target knowledge 104 for herself/himself.

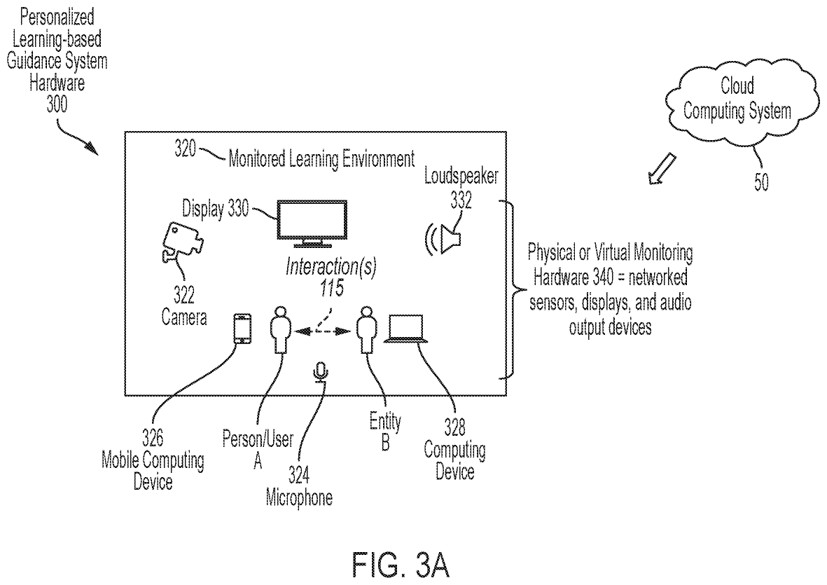

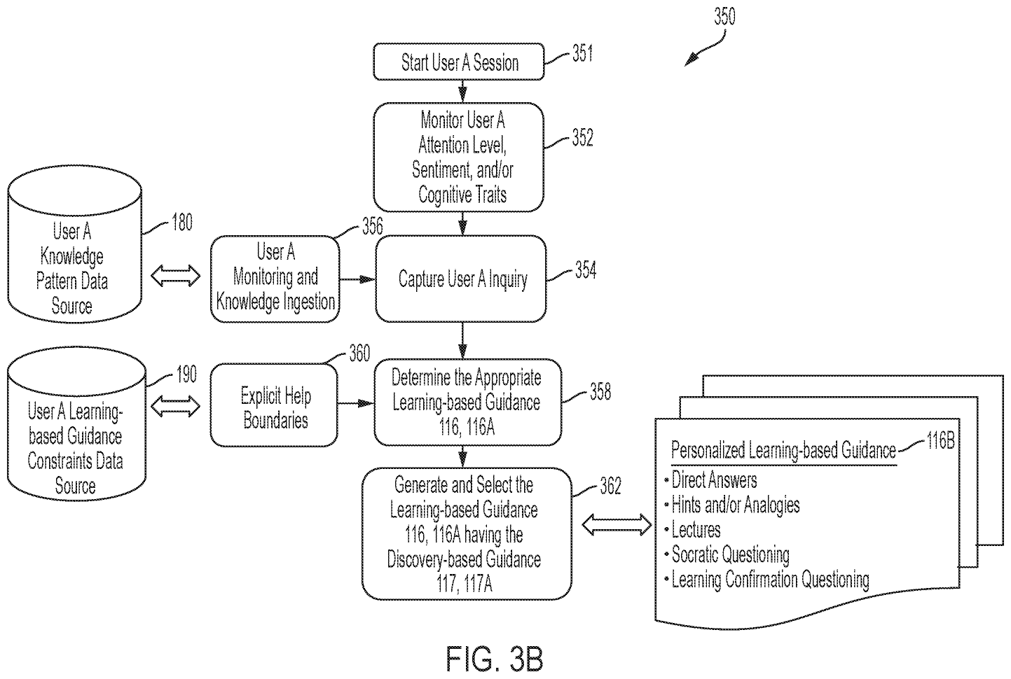

FIG. 3A depicts a diagram illustrating a personalized learning-based guidance system hardware 300 according to embodiments of the invention. The system hardware 300 includes a physical or virtual monitoring hardware configuration 340 configured and arranged to execute any or all aspects of the invention described herein. The monitoring hardware 340 is configured and arranged to monitor a learning environment 320. In accordance with aspects of the invention, the environment 320 can be any suitable environment (e.g., a home or a classroom) in which it is desirable to provide the personalized learning-based guidance 116, 116A (shown in FIGS. 1A and 1B) and the personalized discovery-based guidance 117, 117A (shown in FIGS. 1A and 1B) to Person/User A. In embodiments of the invention, the physical or virtual monitoring hardware 340 can include networked sensors (e.g., camera 322, microphone 324, mobile computing device 326, computing device 328), displays (e.g., display 330), and audio output devices (e.g., loudspeakers 332, mobile computing device 326, computing device 328) configured and arranged to interact with and monitor the activities of User A and/or Entity B within the monitored learning environment 320 to generate data (e.g., monitoring data, training data, learning data, etc.) about User A; the interactions 115 between User A and Entity B; and the environment 320. In embodiments of the invention, the camera 322 can be implemented as multiple camera instances integrated with the mobile computing device 326, the computing device 328, and/or the display 320. In embodiments of the invention, the networked sensors of the physical or virtual monitoring hardware 340 can be configured and arranged to interact with and monitor the activities of Person/User A interacting with (e.g., conversations, gestures, facial expressions, and the like) Entity B within the monitored learning environment 320 to generate data (e.g., monitoring data, training data, learning data, etc.) about how User A and Entity B interact within the environment 320 (i.e., the interactions 115).

In some embodiments of the invention, the physical/virtual environment 320 is a classroom or a home, User A is a student, Entity B is parent/teacher/guardian, and the interaction 115 between User A and Entity B captures how the parents, guardian, and teachers are interacting with the student, such as when a teacher/parent/guardian answers as question directly; when a teacher/parent/guardian gives a hint; and/or when a teacher/parent/guardian asks the student to give it a try. The interactions 115 between User A and Entity B can be captured via conversation analysis APIs (application program interfaces) of the monitoring hardware 340 in order to perform reinforcement learning in accordance with aspects of the invention. The mobile computing device 326, the computing device 328, and/or the display 328 of the can be implemented as a programmable computer (e.g., computing system 1100 shown in FIG. 11) that includes algorithms configured and arranged to implement the various systems and methodologies in accordance with aspects of the invention as described herein.

In some embodiments of the invention, the physical/virtual environment 320 can be virtual in that hardware 340 can be in multiple physical locations and placed in communication with one another over a network. For example, where User A is a student, and where Entity B is a teacher, the environment 320 can include a classroom where an instance of the monitoring hardware 340 is installed, along with any location where User A can receive network connectivity through User A's mobile computing device 326 to the hardware 340 installed in the classroom. The features and functionality of the systems 100, 100A can be distributed among the mobile computing device 326 and the monitoring hardware 340 in any combination such that User A can call up an instance of the personalized Q&A module 110, 110A on User A's mobile computing device 326, enter a User A inquiry 114 to the mobile computing device 326, and utilize the mobile computing device 326 and/or the remotely located monitoring hardware 340 to access all of the features and functionality of the system 100, 100A described herein.

In accordance with aspects of the invention, the cloud computing system 50 (also shown in FIGS. 1A, 1B, 11, and 12) can be in wired or wireless electronic communication with the system hardware 300. The cloud computing system 50 can supplement, support or replace some or all of the functionality of the system hardware 300 and/or the physical or virtual monitoring hardware 340. Additionally, some or all of the functionality of the system hardware 300 and/or the physical or virtual monitoring hardware 340 can be implemented as a node 10 (shown in FIGS. 12 and 13) of the cloud computing system 50. Additionally, in some embodiments of the invention, some or all of the functionality described herein as being executed by the system hardware 300 can be distributed among any of the devices of the monitoring hardware 340 that have sufficient processor and storage capability (e.g., mobile computing device 326, computing device 328) to execute the functionality.

FIG. 3B depicts a flow diagram illustrating a methodology 350 that can be executed by the systems 100, 100A (shown in FIGS. 1A and 1B) running on the system hardware 300 (shown in FIG. 3A) according to embodiments of the invention. The methodology 350 begins at block 351 by starting a User A session, which can be executed by using any suitable method to enable the system hardware 300 to recognize User A (e.g., voice recognition, fingerprint recognition, image recognition, a password, and the like). At block 352, the monitoring hardware 340 is used to monitor the attention level, sentiment, emotional state, and/or cognitive traits of User A. In embodiments of the invention, block 352 can be implemented using the User A emotional state model 120 and/or the User A cognitive trait model 140 (both shown in FIG. 1B). At block 356, the system hardware 300 accesses the User A knowledge pattern data source 180 in order to ingest details about a corpus of information about what User A knows (or should know) about a variety of topics, as well as information about the ways in which User A most effectively learns information. In embodiments of the invention where User A is a student, the data source 180 can include study topic contents, syllabus, topic hints, User A interaction patterns, and/or User A behaviors as a student.

At block 354, the system hardware 300 accesses the User A inquiry 114 (shown in FIGS. 1A and 1B) and uses outputs from blocks 352, 356 to analyze the User A inquiry 114. In embodiments of the invention, the analysis performed at block 354 can include the analysis performed by the User A knowledge pattern models 160, 160A (shown in FIGS. 1A, 1B, and/or 4A). At block 360, the system hardware 300 accesses the User A learning-based guidance constraints data source 190 in order to ingest details about specific help boundaries that will be applied to the learning-based guidance. In embodiments of the invention, the User A learning-based guidance constraints data source 190 is a data source that holds a corpus of information about constraints, if any, that are placed on the delivery to User A of the personalized learning-based guidance 116, 116A and the personalized discovery-based guidance 117, 117A generated by the personalized Q&A module 110A. For example, in embodiments of the invention where User A is a student, and where the system 100A is configured to support questions related to User A's studies, the constraints stored at data source 190 can be set by parents, guardians, and teachers to explicitly state the level of help that the system 100, 100A can provide to User A on a specified topic. Under some circumstances, a teacher can determine that User A's progress with the specified subject would be hindered by reliance on the system 100, 100A, so a constraint could be provided that requires that no personalized learning-based guidance 116, 116A will be provided if the User A inquiry 114 relates to the specified subject matter.

At block 358, the system hardware 300 accesses the outputs from blocks 354 and 360 to determine the appropriate learning-based guidance 116, 116A. In embodiments of the invention, the analysis performed at block 358 can include that analysis performed by the User A knowledge pattern models 160, 160A (shown in FIGS. 1A, 1B, 4A, and/or 4B). At block 362, the system hardware 300 generates the personalized learning-based guidance 116, 116A, which can take the form of the table 116B (also shown in FIG. 2), and selects the personalized learning-based guidance 116, 116A that will be selected from the table 116B and output to User A.

FIG. 4A depicts an example of how the User A knowledge pattern model 160 (shown in FIGS. 1A and 1B) can be implemented as a User A knowledge pattern model 160A. The model 160A includes all of the features and functionality described herein for the model 160 but provides additional details about how some features and functionality of the model 160 can be implemented. In embodiments of the invention, the User A knowledge pattern model 160A includes a User A learning styles sub-model 162 and a User A historical/existing knowledge sub-model 102A. In accordance with aspects of the invention, the User A knowledge pattern model 160A can be a machine learning model that has been trained to extract features from the User A corpus 115A (which includes the interactions 115), the User A inquiry 114, outputs from the User A cognitive trait model 140, outputs from the User A emotional state model 120, outputs from a User A learning styles sub-model 162, and outputs from a User A historical/existing knowledge sub-model 102A in order to perform the task of determining a User A knowledge pattern guidance 168. In embodiments of the invention, the User A knowledge pattern guidance 168 is User A's preferential and/or most effective knowledge acquisition process or method that enables User A to acquire/learn (or assists User A with acquiring/learning) the User A target knowledge 104 (shown in FIGS. 1A and 1B). The personalized Q&A modules 110, 110A (shown in FIGS. 1A and 1B) leverage the User A knowledge pattern (or User A knowledge acquisition process) 168 generated by the User A knowledge pattern model 160A to generate the personalized learning-based guidance 116, 116A, which includes the personalized discovery-based guidance 117, 117A.

In embodiments of the invention, the User A learning styles sub-model 162 is configured to utilize the various inputs to the User A knowledge model 160A to learn to perform the task of determining the learning styles of User A. As used herein, the terms “learning styles” and variations thereof are intended to identify the preferential way in which a person absorbs, processes, comprehends and retains information. Examples of learning styles include the so-called VARK model of student learning, wherein VARK is an acronym that refers to four types of learning styles, namely, visual, auditory, reading/writing preference, and kinesthetic. As an example, when learning how to build a clock, some students understand the process by watching a demonstration (or viewing diagrams); some students understand the process by following verbal instructions; some students understand the process by reading written versions of the instructions; and some students understand the instructions through physically manipulating the clock themselves. In embodiments of the invention, the User A historical/existing knowledge sub-model 102A is configured to utilize the various inputs (in any combination) to the User A knowledge model 160A to perform the task of determining and/or estimating what information and/or skills under a variety of topics are currently known by or within the skill sets of User A.

As a non-limiting example of the operation of the User A knowledge pattern model 160A, User A can be a student enrolled in a trigonometry class taught by Entity B. User A is studying at home and needs to know the formula for calculating the tangent of the angle theta (0). User A calls up the personalized Q&A system 100A on User A's mobile computing device 326 and inputs the User A inquiry 114 by verbally asking “What is the formula of tan(θ)”? The system 100A is configured to include the User A knowledge pattern 160 A, which uses the User A inquiry 114, the User A corpus 115A (which includes the interactions 115), outputs from the User A cognitive trait model 140, outputs from the User A emotional state model 120, outputs from a User A learning styles sub-model 162, and outputs from a User A historical/existing knowledge sub-model 102A in order to perform the task of determining the User A knowledge pattern guidance 168. In this example, the model 160A can make a preliminary determination, based on User A corpus 115A and the User A historical/existing knowledge sub-model 162, that the most effective knowledge acquisition process for User A in response to a trigonometry question about calculating angles of a right triangle is to present User A with hints and/or analogies, an example of which is shown as PLG Option-1 in FIG. 2. The model 160A can then further evaluate the preliminary evaluation in light of the outputs from the User A cognitive trait model 140, outputs from the User A emotional state model 120, and outputs from the User A learning styles sub-model 162 in order to make any necessary adjustments to the preliminary evaluation. The outputs from the models 120, 140 can indicate that User A is in a very good emotional and cognitive position to perform the task of working through hints/analogies so not adjustments are made to the preliminary evaluation. However, in this example, the output from sub-model 162 indicates that User A's most effective learning style for mathematics is watching a demonstration (or viewing diagrams), so the model 160A can modify its preliminary evaluation by recommending that the most effective knowledge acquisition process for User A in response to a trigonometry question about calculating angles of a right triangle is to present User A with hints and/or analogies and to augment the hints/analogies with a demonstration (diagrams, animated video, etc.).

In another non-limiting example of the operation of the User A knowledge pattern model 160A, the scenario is the same as the immediately preceding example except the output from the User A emotional state model 120 indicates that User A is displaying a high level of impatience and general agitation right now despite the fact that the output from the User A cognitive trait model 140 indicates that User A is typically a patient person. Accordingly, the model 160A can modify its preliminary evaluation by recommending that, because the User A emotional state model 120 indicates that User A is displaying a high level of impatience and general agitation right now despite the fact that the output from the User A cognitive trait model 140 indicates that User A is typically a patient person, the preliminary recommendation that the most effective knowledge acquisition process for User A in response to a trigonometry question about calculating angles of a right triangle is to present User A with hints and/or analogies and to augment the hints/analogies with a demonstration (diagrams, animated video, etc.) can be modified to presenting User A with a direct answer augmented with a demonstration (diagrams, animated, video, etc.).

In embodiments of the invention, the database 180 (shown in FIGS. 1B and 3A) includes sufficient processing power (e.g., a relational database management system (RDBMS)) to build the User A corpus 115A. FIG. 4B depicts a suitable RNN encoder 400 that can be used by the database 180 to capture historical interactions 115 between User A, Entity B and the system hardware 340 (shown in FIG. 3A). A wide variety of encoders are suitable for use in aspects of the invention. Because the encoder 400 is known in the art, it will be described at a higher level in the interest of brevity. Sentence tokenization and monitoring of User A's states via long short-term memory (LSTM) and convolutional neural networks (CNN) can be used in order to capture User A information, Entity B information, and the interactions 115 in order to generate the User A corpus 115A. The RNN encoder 400 can be a bi-directional GRU/LSTM, where GRU is a gate recurrent unit. The output of the RNN encoder 400 is a series of hidden vectors in the forward and backward direction, which can be concatenated. The hidden vectors are representations of previous inputs. Similarly, the same RNN Encoder 400 can be used to create question hidden vectors. Voice response functionality of the system hardware 340 captures how Entity B and User A interact with one another. For example, where User A is a student, and Entity B is parents, guardian, and teachers that are interacting with User A, the system hardware 340 captures interaction 115 such as when Entity B responds to a User A inquiry 114 with direct answers, when Entity B responds to User A by giving a hint, and when Entity B responds to User A by suggesting that User A give it a try. Conversation analysis APIs can be used to monitor conversation-based interactions 115 using the disclosed reinforcement learning techniques.

FIG. 4C depicts an example RNN 440, which illustrations hidden state operations of the RNN encoder 400 shown in FIG. 4B. The RNN 440 is particularly suited for processing and making predictions about sequence data having a particular order in which one thing follows another. The RNN 440 includes a layer of input(s), hidden layer(s), and a layer of output(s). A feed-forward looping mechanism acts as a highway to allow hidden states of the RNN 440 to flow from one step to the next. As previously described herein, hidden states are a representations of previous inputs.

FIG. 4D depicts a methodology 450, which is an example of how portions of the User A emotional state model 120 can perform the supporting sub-task of classifying a current emotional state of User A, which is utilized by the module 110A to generate the personalized learning-based guidance 116A and the discovery-based guidance 117A. In accordance with aspects of the invention, the monitoring hardware 340 and the systems 100, 100A are configured to perform the methodology 450 for determining an inattention level of User A. The methodology 450 includes a face detection block 452, a face pose block 454, a facial expressions analysis block 456, a PERCLOS (percentage of eyelid closure over the pupil over time) drowsiness estimation block 458, and a data fusion block 460, configured and arranged as shown. The specific function of each block of the methodology 450 is well known in the art so, in the interest of brevity, those details will not be repeated here.

FIG. 5 depicts a diagram illustrating additional details of how to implement any portion of the systems 100, 100A that is configured to apply machine learning techniques to input data 111 and/or User A corpus data 115A to output a User A cognitive state model and/or data identifying User A's cognitive state in accordance with aspects of the invention. More specifically, FIG. 5 depicts a user cognitive trait assessment module 540, which can be incorporated as part of the ML algorithms 312 (shown in FIG. 2A) of the system 100A. The user cognitive trait assessment module 540 includes a graphical text analyzer 504, a graph constructing circuit 506, a graphs repository 508, a User A model 510, a decision engine 512, an “other” analyzer 520, a current/historical user models module 532, and a current/historical user interactions module 534, all of which are communicatively coupled to one another. The example module 540 focuses on User A for ease of illustration and explanation. However, it is understood that the module 540 analyzes input data 502 and generates cognitive state outputs for all users in the environment 320 (shown in FIG. 3A).

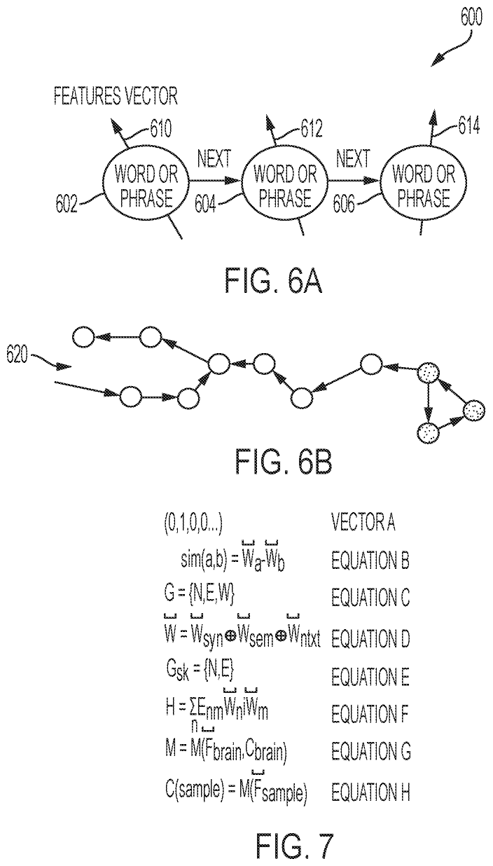

Graphical text analyzer 504 receives the input data 111 and the User a corpus 115A, and graph constructing circuit 506 receives data of User A from graphical text analyzer circuit 504. Graph constructing circuit 506 builds a graph 508 from the received data. More specifically, in some embodiments of the invention wherein the received data is text data, the graph constructing circuit 506 extracts syntactic features from the received text and converts the extracted features into vectors, examples of which are shown in FIGS. 6A and 6B and described in greater detail below. These syntactic vectors can have binary components for the syntactic categories such as verb, noun, pronoun, adjective, lexical root, etc. For instance, a vector [0, 1, 0, 0 . . . ] represents a noun-word in some embodiments of the invention.

Details of an embodiment of the graphical text analyzer 504 will now be provided with reference to FIGS. 6A, 6B, 7 and 8. Referring now to FIG. 6A, there is depicted a graphical text analyzer's output feature vector in the form of a word graph 600 having an ordered set of words or phrases shown as nodes 602, 604, 606, each represented by its own features vector 610, 612, 614 according to one or more embodiments of the invention. Each features vector 610, 612, 614 is representative of some additional feature of its corresponding node 602, 604, 606 in some word/feature space. Word graph 600 is useful to extract topological features for certain vectors, for example, all vectors that point in the upper quadrant of the feature space of words. The dimensions of the word/feature space might be parts of speech (verbs, nouns, adjectives), or the dimensions can be locations in a lexicon or an online resource of the semantic categorization of words in a feature space such as WordNet, which is the trade name of a large lexical database of English. In WordNet, nouns, verbs, adjectives and adverbs are grouped into sets of cognitive synonyms (synsets), each expressing a distinct concept. Synsets are interlinked by means of conceptual-semantic and lexical relations. The resulting network of meaningfully related words and concepts can be navigated with a browser. WordNet is also freely and publicly available for download from the WorldNet website, www.worldnet.princeton.edu. The structure of WordNet makes it a useful tool for computational linguistics and natural language processing.

FIG. 6B illustrates a graph 620 for a group of persons (e.g., two persons depicted as spotted nodes and white nodes). Specifically, for example, the nodes for one person are spotted, and the nodes for another person are depicted in white. The graph 620 can be built for all persons in the group or constructed by combining graphs for individual persons. In some embodiments of the invention, the nodes of the graph 620 can be associated with identities of the persons.

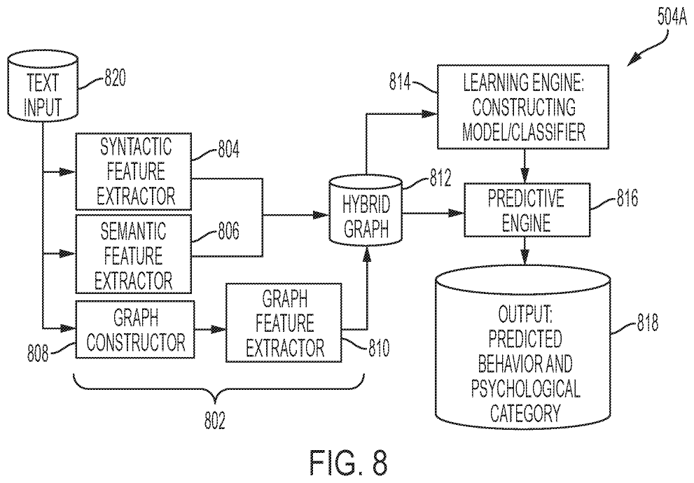

FIG. 7 depicts Vector A and Equations B-H, which illustrate features of a core algorithm that can be implemented by graphical text analyzer 504A (shown in FIG. 8) having a graphical text analysis module 802 (shown in FIG. 8) according to one or more embodiments of the invention. Graphical text analyzer 504A shown in FIG. 8 is an implementation of graphical text analyzer 504 (shown in FIG. 5), wherein text input 820 receives text of User A and/or User A corpus 115A. The text received at text input 820 can be text that has been converted from some other form (e.g., speech) to text. The functionality that converts other, non-text data of User A to text can be provided in the graphical text analyzer 504 or as a stand-alone circuit.

Continuing with a description of Vector A and Equations B-H of FIG. 7 including selected references to corresponding elements of graphical text analyzer 504A and graphical text analysis module 802 shown in FIG. 8, text or speech-to-text is fed into a standard lexical parser (e.g., syntactic feature extractor 804 of FIG. 8) that extracts syntactic features, which are converted to vectors. Such vectors can have binary components for the syntactic categories verb, noun, pronoun, etcetera, such that the vector represented by Vector A represents a noun word.

The text is also fed into a semantic analyzer (e.g., semantic feature extractor 806 of FIG. 8) that converts words into semantic vectors. The conversion into semantic vectors can be implemented in a number of ways, including, for example, the use of latent semantic analysis. The semantic content of each word is represented by a vector whose components are determined by the singular value decomposition of word co-occurrence frequencies over a large database of documents. As a result, the semantic similarity between two words “a” and “b” can be estimated by the scalar product of their respective semantic vectors represented by Equation B.

A hybrid graph is created in accordance with Equation C in which the nodes “N” represent words or phrases, the edges “E” represent temporal precedence in the speech, and each node possesses a feature vector “W” defined as a direct sum of the syntactic and semantic vectors plus additional non-textual features (e.g. the identity of the speaker) as given by Equation D.

The graph “G” of Equation C is then analyzed based on a variety of features, including standard graph-theoretical topological measures of the graph skeleton as shown by Equation E, such as degree distribution, density of small-size motifs, clustering, centrality, etc. Similarly, additional values can be extracted by including the feature vectors attached to each node. One such instance is the magnetization of the generalized Potts model as shown by Equation F such that temporal proximity and feature similarity are taken into account.

The features that incorporate the syntactic, semantic and dynamical components of speech are then combined as a multi-dimensional features vector “F” that represents the speech sample. This feature vector is finally used to train a standard classifier according to Equation G to discriminate speech samples that belong to different conditions “C,” such that for each test speech sample the classifier estimates its condition identity based on the extracted features represented by Equation H.

FIG. 8 depicts a diagram of graphical text analyzer 504A having a graphical text analysis circuit 802 according to one or more embodiments. Graphical text analyzer 504A is an implementation of graphical text analyzer module 504 (shown in FIG. 5). Graphical text analyzer 504A includes text input 820, a syntactic feature extractor 804, a semantic feature extractor 806, a graph constructor 808, a graph feature extractor 810, a hybrid graph circuit 812, a learning engine 814, a predictive engine 816 and an output circuit 818, configured and arranged as shown. In general, graphical text analysis circuit 802 functions to convert inputs from text input circuit 820 into hybrid graphs (e.g., word graph 600 shown in FIG. 6A), which is provided to learning engine 814 and predictive engine 816.

As noted, the graphical text analyzer circuit 802 provides word graph inputs to learning engine 814, and predictive engine 816, which constructs predictive features or model classifiers of the state of the individual in order to predict what the next state will be, i.e., the predicted behavioral or psychological category of output circuit 818. Accordingly, predictive engine 816 and output circuit 818 can be modeled as Markov chains.

Referring again to FIG. 5, User A model 510 receives cognitive trait data from graphical text analyzer 504 and determines a model 510 of User A based at least in part on the received cognitive trait data. User-A model 510 is, in effect, a profile of User A that organizes and assembles the received cognitive trait data into a format suitable for use by decision engine 512. Optionally, the profile generated by User A model 510 can be augmented by output from “other” analyzer 520, which provides analysis, other than graphical text analysis, of the input data 502 of User A. For example, other analyzer 520 can track the specific interactions of User A with Entity B in the environment 320 (shown in FIG. 3A) such as gaze and eye movement interactions, such that User A model 510 can match received cognitive trait data with specific interactions. The output of User A model 510 is provided to decision engine 512, which analyzes the output of User A model 510 to make a determination about the cognitive traits of User A.

The cognitive trait assessment module 540 performs this analysis on all users in the environment 320 (shown in FIG. 3A) and makes the results of prior analyses available through current/historical user models 532 and current/historical user interactions 534, which can be provided to decision engine 512 for optional incorporation into the determination of User A's cognitive state and/or User A's cognitive model 510.

Additional details of machine learning techniques that can be used to aspects of the invention disclosed herein will now be provided. The various types of computer control functionality of the processors described herein can be implemented using machine learning and/or natural language processing techniques. In general, machine learning techniques are run on so-called “neural networks,” which can be implemented as programmable computers configured to run sets of machine learning algorithms and/or natural language processing algorithms. Neural networks incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical).

The basic function of neural networks and their machine learning algorithms is to recognize patterns by interpreting unstructured sensor data through a kind of machine perception. Unstructured real-world data in its native form (e.g., images, sound, text, or time series data) is converted to a numerical form (e.g., a vector having magnitude and direction) that can be understood and manipulated by a computer. The machine learning algorithm performs multiple iterations of learning-based analysis on the real-world data vectors until patterns (or relationships) contained in the real-world data vectors are uncovered and learned. The learned patterns/relationships function as predictive models that can be used to perform a variety of tasks, including, for example, classification (or labeling) of real-world data and clustering of real-world data. Classification tasks often depend on the use of labeled datasets to train the neural network (i.e., the model) to recognize the correlation between labels and data. This is known as supervised learning. Examples of classification tasks include detecting people/faces in images, recognizing facial expressions (e.g., angry, joyful, etc.) in an image, identifying objects in images (e.g., stop signs, pedestrians, lane markers, etc.), recognizing gestures in video, detecting voices, detecting voices in audio, identifying particular speakers, transcribing speech into text, and the like. Clustering tasks identify similarities between objects, which it groups according to those characteristics in common and which differentiate them from other groups of objects. These groups are known as “clusters.”

An example of machine learning techniques that can be used to implement aspects of the invention will be described with reference to FIGS. 9 and 10. Machine learning models configured and arranged according to embodiments of the invention will be described with reference to FIG. 9. Detailed descriptions of an example computing system and network architecture capable of implementing one or more of the embodiments of the invention described herein will be provided with reference to FIG. 11.

FIG. 9 depicts a block diagram showing a machine learning or classifier system 900 capable of implementing various aspects of the invention described herein. More specifically, the functionality of the system 900 is used in embodiments of the invention to generate various models and sub-models that can be used to implement computer functionality in embodiments of the invention. The system 900 includes multiple data sources 902 in communication through a network 904 with a classifier 910. In some aspects of the invention, the data sources 902 can bypass the network 904 and feed directly into the classifier 910. The data sources 902 provide data/information inputs that will be evaluated by the classifier 910 in accordance with embodiments of the invention. The data sources 902 also provide data/information inputs that can be used by the classifier 910 to train and/or update model(s) 916 created by the classifier 910. The data sources 902 can be implemented as a wide variety of data sources, including but not limited to, sensors configured to gather real time data, data repositories (including training data repositories), and outputs from other classifiers. The network 904 can be any type of communications network, including but not limited to local networks, wide area networks, private networks, the Internet, and the like.

The classifier 910 can be implemented as algorithms executed by a programmable computer such as a processing system 1100 (shown in FIG. 11). As shown in FIG. 9, the classifier 910 includes a suite of machine learning (ML) algorithms 912; natural language processing (NLP) algorithms 914; and model(s) 916 that are relationship (or prediction) algorithms generated (or learned) by the ML algorithms 912. The algorithms 912, 914, 916 of the classifier 910 are depicted separately for ease of illustration and explanation. In embodiments of the invention, the functions performed by the various algorithms 912, 914, 916 of the classifier 910 can be distributed differently than shown. For example, where the classifier 910 is configured to perform an overall task having sub-tasks, the suite of ML algorithms 912 can be segmented such that a portion of the ML algorithms 912 executes each sub-task and a portion of the ML algorithms 912 executes the overall task. Additionally, in some embodiments of the invention, the NLP algorithms 914 can be integrated within the ML algorithms 912.

The NLP algorithms 914 include speech recognition functionality that allows the classifier 910, and more specifically the ML algorithms 912, to receive natural language data (text and audio) and apply elements of language processing, information retrieval, and machine learning to derive meaning from the natural language inputs and potentially take action based on the derived meaning. The NLP algorithms 914 used in accordance with aspects of the invention can also include speech synthesis functionality that allows the classifier 910 to translate the result(s) 920 into natural language (text and audio) to communicate aspects of the result(s) 920 as natural language communications.

The NLP and ML algorithms 914, 912 receive and evaluate input data (i.e., training data and data-under-analysis) from the data sources 902. The ML algorithms 912 includes functionality that is necessary to interpret and utilize the input data's format. For example, where the data sources 902 include image data, the ML algorithms 912 can include visual recognition software configured to interpret image data. The ML algorithms 912 apply machine learning techniques to received training data (e.g., data received from one or more of the data sources 902) in order to, over time, create/train/update one or more models 916 that model the overall task and the sub-tasks that the classifier 910 is designed to complete.

Referring now to FIGS. 9 and 10 collectively, FIG. 10 depicts an example of a learning phase 1000 performed by the ML algorithms 912 to generate the above-described models 916. In the learning phase 1000, the classifier 910 extracts features from the training data and coverts the features to vector representations that can be recognized and analyzed by the ML algorithms 912. The features vectors are analyzed by the ML algorithm 912 to “classify” the training data against the target model (or the model's task) and uncover relationships between and among the classified training data. Examples of suitable implementations of the ML algorithms 912 include but are not limited to neural networks, support vector machines (SVMs), logistic regression, decision trees, hidden Markov Models (HMMs), etc. The learning or training performed by the ML algorithms 912 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier 910 and the ML algorithms 912. Unsupervised learning can utilize additional learning/training methods including, for example, clustering, anomaly detection, neural networks, deep learning, and the like.

When the models 916 are sufficiently trained by the ML algorithms 912, the data sources 902 that generate “real world” data are accessed, and the “real world” data is applied to the models 916 to generate usable versions of the results 920. In some embodiments of the invention, the results 920 can be fed back to the classifier 910 and used by the ML algorithms 912 as additional training data for updating and/or refining the models 916.

In aspects of the invention, the ML algorithms 912 and the models 916 can be configured to apply confidence levels (CLs) to various ones of their results/determinations (including the results 920) in order to improve the overall accuracy of the particular result/determination. When the ML algorithms 912 and/or the models 916 make a determination or generate a result for which the value of CL is below a predetermined threshold (TH) (i.e., CL<TH), the result/determination can be classified as having sufficiently low “confidence” to justify a conclusion that the determination/result is not valid, and this conclusion can be used to determine when, how, and/or if the determinations/results are handled in downstream processing. If CL>TH, the determination/result can be considered valid, and this conclusion can be used to determine when, how, and/or if the determinations/results are handled in downstream processing. Many different predetermined TH levels can be provided. The determinations/results with CL>TH can be ranked from the highest CL>TH to the lowest CL>TH in order to prioritize when, how, and/or if the determinations/results are handled in downstream processing.

In aspects of the invention, the classifier 910 can be configured to apply confidence levels (CLs) to the results 920. When the classifier 910 determines that a CL in the results 920 is below a predetermined threshold (TH) (i.e., CL<TH), the results 920 can be classified as sufficiently low to justify a classification of “no confidence” in the results 920. If CL>TH, the results 920 can be classified as sufficiently high to justify a determination that the results 920 are valid. Many different predetermined TH levels can be provided such that the results 920 with CL>TH can be ranked from the highest CL>TH to the lowest CL>TH.

The functions performed by the classifier 910, and more specifically by the ML algorithm 912, can be organized as a weighted directed graph, wherein the nodes are artificial neurons (e.g. modeled after neurons of the human brain), and wherein weighted directed edges connect the nodes. The directed graph of the classifier 910 can be organized such that certain nodes form input layer nodes, certain nodes form hidden layer nodes, and certain nodes form output layer nodes. The input layer nodes couple to the hidden layer nodes, which couple to the output layer nodes. Each node is connected to every node in the adjacent layer by connection pathways, which can be depicted as directional arrows that each has a connection strength. Multiple input layers, multiple hidden layers, and multiple output layers can be provided. When multiple hidden layers are provided, the classifier 910 can perform unsupervised deep-learning for executing the assigned task(s) of the classifier 910.

Similar to the functionality of a human brain, each input layer node receives inputs with no connection strength adjustments and no node summations. Each hidden layer node receives its inputs from all input layer nodes according to the connection strengths associated with the relevant connection pathways. A similar connection strength multiplication and node summation is performed for the hidden layer nodes and the output layer nodes.

The weighted directed graph of the classifier 910 processes data records (e.g., outputs from the data sources 902) one at a time, and it “learns” by comparing an initially arbitrary classification of the record with the known actual classification of the record. Using a training methodology knows as “back-propagation” (i.e., “backward propagation of errors”), the errors from the initial classification of the first record are fed back into the weighted directed graphs of the classifier 910 and used to modify the weighted directed graph's weighted connections the second time around, and this feedback process continues for many iterations. In the training phase of a weighted directed graph of the classifier 910, the correct classification for each record is known, and the output nodes can therefore be assigned “correct” values. For example, a node value of “1” (or 0.9) for the node corresponding to the correct class, and a node value of “0” (or 0.1) for the others. It is thus possible to compare the weighted directed graph's calculated values for the output nodes to these “correct” values, and to calculate an error term for each node (i.e., the “delta” rule). These error terms are then used to adjust the weights in the hidden layers so that in the next iteration the output values will be closer to the “correct” values.

FIG. 11 depicts a high level block diagram of the computer system 1100, which can be used to implement one or more computer processing operations in accordance with aspects of the present invention. Although one exemplary computer system 1100 is shown, computer system 1100 includes a communication path 1125, which connects computer system 1100 to additional systems (not depicted) and can include one or more wide area networks (WANs) and/or local area networks (LANs) such as the Internet, intranet(s), and/or wireless communication network(s). Computer system 1100 and the additional systems are in communication via communication path 1125, e.g., to communicate data between them. In some embodiments of the invention, the additional systems can be implemented as one or more cloud computing systems 50. The cloud computing system 50 can supplement, support or replace some or all of the functionality (in any combination) of the computer system 1100, including any and all computing systems described in this detailed description that can be implemented using the computer system 1100. Additionally, some or all of the functionality of the various computing systems described in this detailed description can be implemented as a node of the cloud computing system 50.

Computer system 1100 includes one or more processors, such as processor 1102. Processor 1102 is connected to a communication infrastructure 1104 (e.g., a communications bus, cross-over bar, or network). Computer system 1100 can include a display interface 1106 that forwards graphics, text, and other data from communication infrastructure 1104 (or from a frame buffer not shown) for display on a display unit 1108. Computer system 1100 also includes a main memory 1110, preferably random access memory (RAM), and can also include a secondary memory 1112. Secondary memory 1112 can include, for example, a hard disk drive 1114 and/or a removable storage drive 1116, representing, for example, a floppy disk drive, a magnetic tape drive, or an optical disk drive. Removable storage drive 1116 reads from and/or writes to a removable storage unit 1118 in a manner well known to those having ordinary skill in the art. Removable storage unit 1118 represents, for example, a floppy disk, a compact disc, a magnetic tape, or an optical disk, flash drive, solid state memory, etc. which is read by and written to by removable storage drive 1116. As will be appreciated, removable storage unit 1118 includes a computer readable medium having stored therein computer software and/or data.

In alternative embodiments of the invention, secondary memory 1112 can include other similar means for allowing computer programs or other instructions to be loaded into the computer system. Such means can include, for example, a removable storage unit 1120 and an interface 1122. Examples of such means can include a program package and package interface (such as that found in video game devices), a removable memory chip (such as an EPROM, or PROM) and associated socket, and other removable storage units 1120 and interfaces 1122 which allow software and data to be transferred from the removable storage unit 1120 to computer system 1100.

Computer system 1100 can also include a communications interface 1124. Communications interface 1124 allows software and data to be transferred between the computer system and external devices. Examples of communications interface 1124 can include a modem, a network interface (such as an Ethernet card), a communications port, or a PCM-CIA slot and card, etcetera. Software and data transferred via communications interface 1124 are in the form of signals which can be, for example, electronic, electromagnetic, optical, or other signals capable of being received by communications interface 1124. These signals are provided to communications interface 1124 via communication path (i.e., channel) 1125. Communication path 1125 carries signals and can be implemented using wire or cable, fiber optics, a phone line, a cellular phone link, an RF link, and/or other communications channels.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 12, illustrative cloud computing environment 50 is depicted. As shown, cloud computing environment 50 comprises one or more cloud computing nodes 13 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 12 are intended to be illustrative only and that computing nodes 10 and cloud computing environment 50 can communicate with any type of computerized device over any type of network and/or network addressable connection (e.g., using a web browser).

Referring now to FIG. 13, a set of functional abstraction layers provided by cloud computing environment 50 (FIG. 12) is shown. It should be understood in advance that the components, layers, and functions shown in FIG. 13 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the personalized Q&A system for generating personalized learning-based guidance 96.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, a process, a method, an article, or an apparatus that comprises a list of elements is not necessarily limited to only those elements but can include other elements not expressly listed or inherent to such composition, mixture, process, method, article, or apparatus.

The terminology used herein is for the purpose of describing particular embodiments of the invention only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Additionally, the term “exemplary” and variations thereof are used herein to mean “serving as an example, instance or illustration.” Any embodiment or design described herein as “exemplary” is not necessarily to be construed as preferred or advantageous over other embodiments or designs. The terms “at least one,” “one or more,” and variations thereof, can include any integer number greater than or equal to one, i.e. one, two, three, four, etc. The terms “a plurality” and variations thereof can include any integer number greater than or equal to two, i.e., two, three, four, five, etc. The term “connection” and variations thereof can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The phrases “in signal communication”, “in communication with,” “communicatively coupled to,” and variations thereof can be used interchangeably herein and can refer to any coupling, connection, or interaction using electrical signals to exchange information or data, using any system, hardware, software, protocol, or format, regardless of whether the exchange occurs wirelessly or over a wired connection.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be understood that those skilled in the art, both now and in the future, may make various improvements and enhancements which fall within the scope of the claims which follow.

What is claimed is:

1. A computer-implemented method of generating personalized learning-based guidance, the computer-implemented method comprising:
receiving at a question and answer (Q&A) module a user inquiry from a user;
using a knowledge pattern model of Q&A module to identify a knowledge pattern of the user;
wherein the knowledge pattern of the user comprises a learning-assist process that assists a discovery process implemented by the user and through which the user discovers an answer to the user inquiry; and
using the knowledge pattern to generate the personalized learning-based guidance;
wherein the personalized learning-based guidance comprises a communication configured to assist the user with performing a task of acquiring a target knowledge that can be used by the user to generate the answer to the user inquiry.

2. The computer-implemented method of claim 1, wherein using the knowledge pattern to generate the personalized learning-based guidance comprises using the personalized knowledge pattern to identify relationships between the existing knowledge of the user and the target knowledge.

3. The computer-implemented method of claim 1, wherein the knowledge pattern model has been trained to identify the learning-assist process by extracting features from interactions between the user and an entity.

4. The computer-implemented method of claim 1, wherein:
the knowledge pattern model includes a learning styles sub-model of the user configured to perform a task of outputting a set of learning styles of the user; and
the knowledge pattern model has been trained to identify the learning-assist process by taking into account the set of learning styles of the user output from the knowledge pattern model.

5. The computer-implemented method of claim 1, wherein:
the knowledge pattern model includes an existing knowledge sub-model of the user configured to perform a task of outputting information and skills that are currently known by and within skill sets of the user; and
the knowledge pattern model has been trained to identify the learning-assist process by taking into account the information and skills that are currently known by and within skill sets of the user.

6. The computer-implemented method of claim 1 further comprising using, in addition to the knowledge pattern, constraints to generate the personalized learning-based guidance.

7. The computer-implemented method of claim 1, wherein the communication is selected from the group consisting of an analogy, a hint, a lecture, and a Socratic question.

8. A computer system comprising a processor communicatively coupled to a memory, wherein the processor performs processor operations comprising:
receiving at a question and answer (Q&A) module of the processor a user inquiry from a user;
using a knowledge pattern model of Q&A module to identify a knowledge pattern of the user;
wherein the knowledge pattern of the user comprises a learning-assist process that assists a discovery process implemented by the user and through which the user discovers an answer to the user inquiry; and
using the knowledge pattern to generate the personalized learning-based guidance;
wherein the personalized learning-based guidance comprises a communication configured to assist the user with performing a task of acquiring a target knowledge that can be used by the user to generate the answer to the user inquiry.

9. The computer system of claim 8, wherein using the knowledge pattern to generate the personalized learning-based guidance comprises using the personalized knowledge pattern to identify relationships between the existing knowledge of the user and the target knowledge.

10. The computer system of claim 8, wherein the knowledge pattern model has been trained to identify the learning-assist process by extracting features from interactions between the user and an entity.

11. The computer system of claim 8, wherein:
the knowledge pattern model includes a learning styles sub-model of the user configured to perform a task of outputting a set of learning styles of the user; and
the knowledge pattern model has been trained to identify the learning-assist process by taking into account the set of learning styles of the user output from the knowledge pattern model.

12. The computer system of claim 8, wherein:
the knowledge pattern model includes an existing knowledge sub-model of the user configured to perform a task of outputting information and skills that are currently known by and within skill sets of the user; and
the knowledge pattern model has been trained to identify the learning-assist process by taking into account the information and skills that are currently known by and within skill sets of the user.

13. The computer system of claim 8 further comprising using, in addition to the knowledge pattern, constraints to generate the personalized learning-based guidance.

14. The computer system of claim 8, wherein the communication is selected from the group consisting of an analogy, a hint, a lecture, and a Socratic question.

15. A computer program product for generating personalized learning-based guidance, the computer program product comprising a computer readable program stored on a computer readable storage medium, wherein the computer readable program, when executed on a processor, causes the processor to perform a method comprising:
receiving at a question and answer (Q&A) module of the processor a user inquiry from a user;
using a knowledge pattern model of Q&A module to identify a knowledge pattern of the user;
wherein the knowledge pattern of the user comprises a learning-assist process that assists a discovery process implemented by the user and through which the user discovers an answer to the user inquiry; and
using the knowledge pattern to generate the personalized learning-based guidance;
wherein the personalized learning-based guidance comprises a communication configured to assist the user with performing a task of acquiring a target knowledge that can be used by the user to generate the answer to the user inquiry.

16. The computer program product of claim 15, wherein using the knowledge pattern to generate the personalized learning-based guidance comprises using the personalized knowledge pattern to identify relationships between the existing knowledge of the user and the target knowledge.

17. The computer program product of claim 15, wherein the knowledge pattern model has been trained to identify the learning-assist process by extracting features from interactions between the user and an entity.

18. The computer program product of claim 15, wherein:
the knowledge pattern model includes a learning styles sub-model of the user configured to perform a task of outputting a set of learning styles of the user; and
the knowledge pattern model has been trained to identify the learning-assist process by taking into account the set of learning styles of the user output from the knowledge pattern model.

19. The computer program product of claim 15, wherein:
the knowledge pattern model includes an existing knowledge sub-model of the user configured to perform a task of outputting information and skills that are currently known by and within skill sets of the user; and
the knowledge pattern model has been trained to identify the learning-assist process by taking into account the information and skills that are currently known by and within skill sets of the user.

20. The computer program product of claim 15, wherein the method performed by the processor further comprises using, in addition to the knowledge pattern, constraints to generate the personalized learning-based guidance.
